(19) United States
(12) Patent Application Publication
(10) Pub. No.: US 2008/0288214 A1
(43) Pub. Date: Nov. 20, 2008

(54) SYSTEM AND METHOD FOR TESTING A CAMERA MODULE

(75) Inventors: Chiung-Sheng Wu, Tu-Cheng,Taipei Hsien (TW); Pai-Hsiang Cheng, Tu-Cheng,Taipei Hsien (TW); Yung-Chou Chen, Tu-Cheng,Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng,Taipei Hsien (TW)

(21) Appl. No.: 11/943,507

(22) Filed: Nov. 20, 2007

(30) Foreign Application Priority Data
May 15, 2007 (CN) 200710200614.4

(51) Int. Cl. G21C 17/00

(52) U.S. Cl. 702/186

(57) ABSTRACT

A system for testing a camera module is provided. The system includes a computer and a testing fixture. The testing fixture is connected with the computer. The testing fixture is configured for holding the camera module, converting an image of an image testing chart obtained by the camera module into a computer-recognizable format, and transmitting the converted image to the computer. The computer includes: an area dividing module, an image testing module, and a judging module. The area dividing module is configured for dividing the image into several testing areas. The image testing module is configured for computing values of test factors of the testing areas. The comparison module is configured for determining whether the test factors are satisfactory through comparing the values of the test factors with respective predetermined values. A related method for testing a camera module is also provided.

### BACKGROUND OF THE INVENTION

1. Field of the Invention

The present invention relates, generally, to systems and methods for testing a camera module, and particularly to a system and a method for testing a camera module by testing an image obtained by the camera module.

2. Description of Related Art

When testing a camera module, an image obtained by the camera module is tested for certain qualities such as shading, color, grayness, and resolution. These qualities of the image, called test factors, gave a fairly good representation of the performance of the camera module.

Usually, the tests are performed on workstations. The workstation mainly includes a computer, a testing fixture, and a lamp-house. The lamp-house typically includes a lamp and an image testing chart. The testing method mainly involves the following steps. (1) The camera module to be tested is held on the test fixture. (2) The focus of the camera module is adjusted by moving the testing fixture. (3) The camera module takes an image of the image testing chart. (4) A program installed on the computer tests the test factors through testing the image.

In the conventional testing method, each of the test factors (shading, color, grayness, and resolution) is tested on the corresponding workstation. However, all the workstations are largely identical but with minor differences. The minor differences are that the image testing charts are different, and the sizes of lamp-houses and the positions of the testing fixture differ according to differences in the image testing chart. For example, when testing shading on the corresponding workstation, the image testing chart is a uniform white chart. When testing color on the corresponding workstation, the image testing chart is a colored chart which may have 7 colors. The colors may include white, yellow, cyan, green, magenta, red and blue. Furthermore, the procedures for testing each of the test factors are identical.

Accordingly, the conventional testing method has disadvantages as follows:

(1) each of the test factors needs to be tested in the corresponding workstation, time and resources are thus wasted;
(2) when the image testing chart is large enough, the lamp-house needs to be large, and in order to obtain the intact image of the image testing chart, the testing fixture needs to be far from the image testing chart, thus wasting space.

### SUMMARY OF THE INVENTION

A system for testing a camera module is provided. The system includes a computer and a testing fixture. The testing fixture is connected with the computer. The testing fixture is configured for holding the camera module, converting an image of an image testing chart taken by the camera module into a computer-recognizable format, and transmitting the converted image to the computer. The computer mainly includes an area dividing module, an image testing module, and a judging module. The area dividing module is configured for dividing the image into several testing areas. The image testing module is configured for computing values of test factors of the testing areas. The comparison module is configured for determining whether the test factors are satisfactory through comparing the values of the test factors with respective predetermined values.

Another preferred embodiment provides a computer-based method for testing a camera module. The method includes the following steps. (1) Devices are installed. The installment includes the following steps. The camera module is held on a testing fixture, and is connected with a computer through a signal conversion unit of the testing fixture. An image testing chart is placed above the camera module. The camera module is turned on to take an image of the image testing chart. (2) A processor in the testing fixture converts the image taken by the camera module into a computer-recognizable format. (3) A signal output port of the testing fixture transmits the converted image to the computer. (4) An area dividing module of the computer divides the image into several testing areas. (5) An image testing module of the computer computes values of test factors of the testing areas. (6) A comparison module of the computer determines whether the test factors are satisfactory through comparing the computed values of the test factors with respective predetermined values.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware configuration of a system for testing a camera module in accordance with a preferred embodiment;

FIG. 2 is a block diagram of software function modules of a computer in FIG. 1;

FIG. 3 is a schematic diagram of an image testing chart;

FIG. 4 is a flowchart illustrating a method for testing a camera module in accordance with a preferred embodiment;

FIG. 5 is a diagram illustrating a shading testing area divided from the image testing chart in FIG. 3; and

FIG. 6 is a diagram illustrating a resolution testing area divided from the image testing chart in FIG. 3.

### DETAILED DESCRIPTION OF THE INVENTION

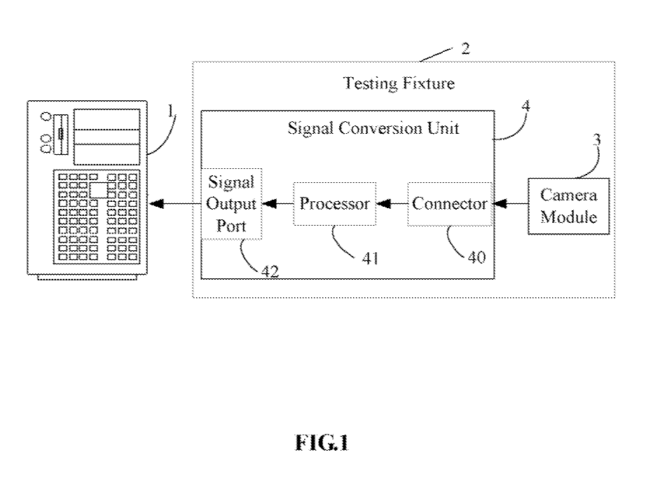

FIG. 1 is a schematic diagram of hardware configuration of a system for testing a camera module (hereinafter “the system”), in accordance with a preferred embodiment. The system typically includes a computer 1 and a testing fixture 2. The testing fixture 2 is used for holding a camera module 3 to be tested. The testing fixture 2 includes a mounting hole for holding the camera module 3, and a fastener near to the mounting hole for stabilizing the camera module 3. The testing fixture 2 further includes a signal conversion unit 4 for converting an image outputted from the camera module 3 into a computer-recognizable format. The signal conversion unit 4 includes a connector 40, a processor 41, and a signal output port 42. The connector 40 is configured for electronically connecting to the camera module 3, and for acquiring images taken by the camera module 3. The processor 41 is configured for converting the image into computer-recognizable format. The signal output port 42 is configured for transmitting the converted image to the computer 1. The signal output port 42 may be a USB port, IEEE1394 type port, or any other suitable ports. The signal output port 42 is connected with the computer 1 via a signal cable.

Further, in order to avoid inaccuracy in test results due to the variations in of environmental lights, the testing fixture 2 may be placed in a darkened test space. A lamp may be fixed above the testing fixture 2, for providing stable and equal light for the camera module 3 to be tested. An image testing chart may be pasted on the upward side of the test space, and above the camera module 3, in order to allow the camera module 3 to take an image of the image testing chart.

Conventionally, the computer 1, the testing fixture 2, and the image testing chart are placed on a horizontal plane. When the image testing chart is large enough, the testing fixture 2 needs to be far enough from the image testing chart to allow the camera module 3 to take the image of the image testing chart. Implementing the method above needs a large test space. Thus, a novel method is provided, in which, the computer 1, the testing fixture 2, and the image testing chart are placed on a vertical plane.

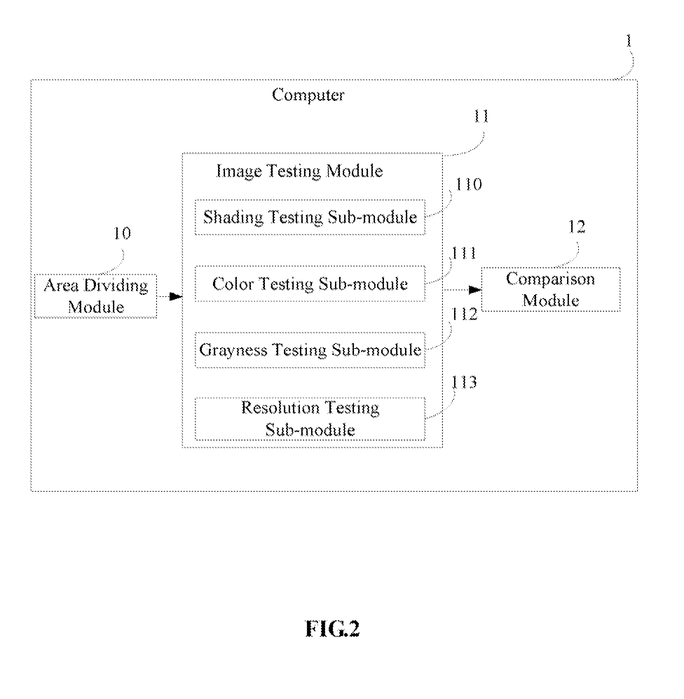

FIG. 2 is a block diagram of software function modules of the computer 1 in FIG. 1. The computer 1 mainly includes: an area dividing module 10, an image testing module 11, and a comparison module 12. The image testing module 11 mainly includes: a shading testing sub-module 110, a color testing sub-module 111, a grayness testing sub-module 112, and a resolution testing sub-module 113.

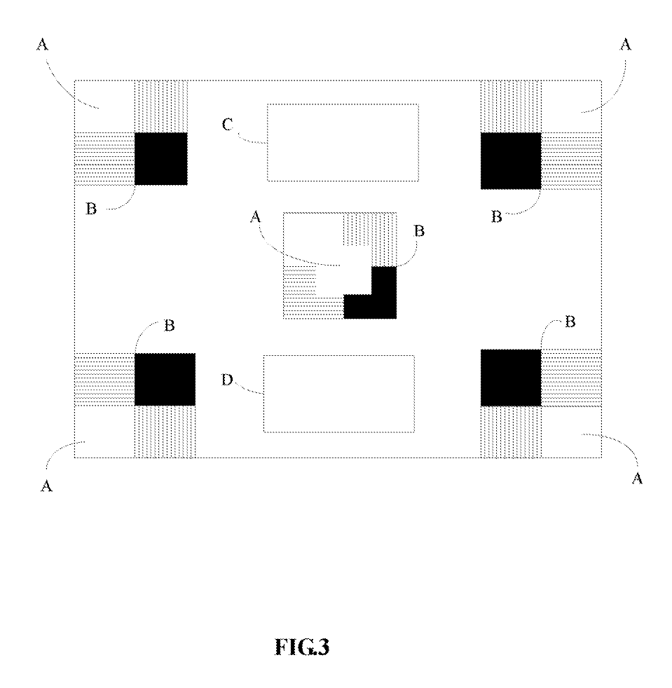

The area dividing module 10 is configured for dividing the image of the image testing chart into several testing areas. The testing areas include a shading testing area, a color testing area, a grayness testing area, and a resolution testing area. In a conventional testing method, test factors (including shading testing, color testing, grayness testing, and resolution testing) of the camera module 3 are made on different image testing charts. For example, the shading testing can be made using a shading image testing chart. The color testing can be made using a color image testing chart. The grayness testing can be made using a grayness image testing chart. The resolution testing can be made using a resolution image testing chart. In the preferred embodiment, the shading image testing chart, the color image testing chart, the grayness image testing chart, and the resolution image testing chart are integrated into an all-in-one image testing chart. In FIG. 3, the area dividing module 10 divides the image of the all-in-one image testing chart into 4 testing areas: shading testing area A, resolution testing area B, color testing area C, and grayness testing area D.

The image testing module 11 is configured for computing values of the test factors of the testing areas.

The shading testing sub-module 110 is configured for computing brightness values of the shading testing area A. The color testing sub-module 111 is configured for computing color values of the color testing area C. The grayness testing sub-module 112 is configured for computing grayness values of the grayness testing area D. The resolution testing sub-module 113 is configured for computing resolution values of the resolution testing area B.

The comparison module 12 is configured for determining whether the test factors are satisfactory by comparing the values of the test factors with respective predetermined values.

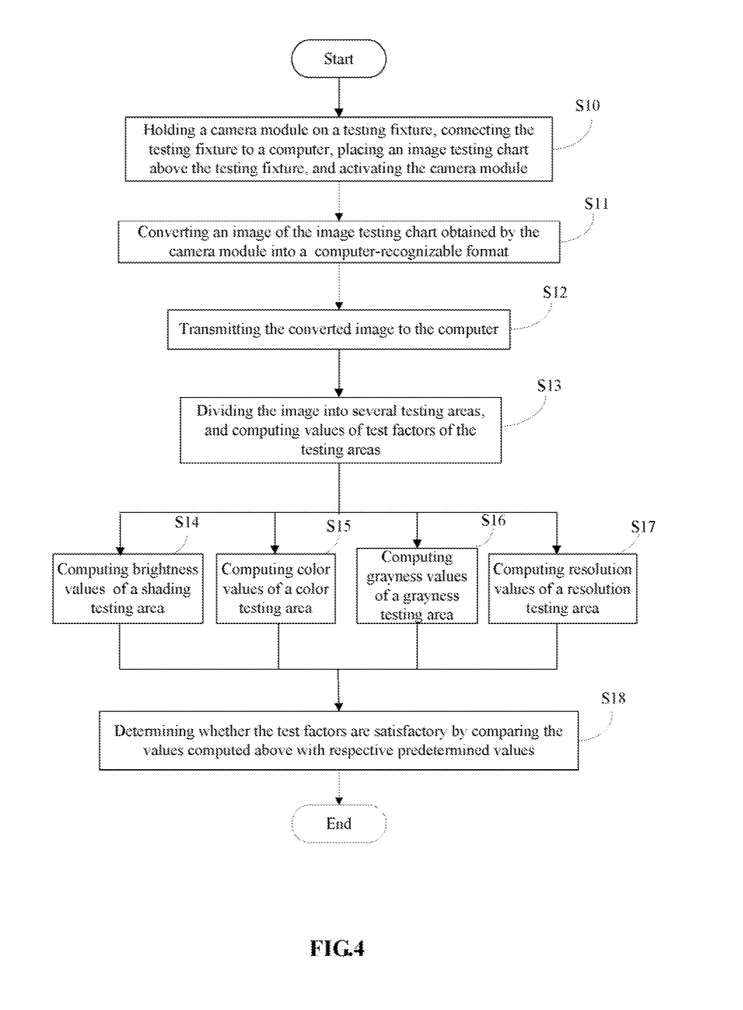

FIG. 4 is a flowchart illustrating a method for testing a camera module in accordance with a preferred embodiment. In step S10, system devices are installed. The installment includes the following steps. (1) The camera module 3 to be tested is held on the testing fixture 2, and is connected with the computer 1 through the signal conversion unit 4 of the testing fixture 2. (2) The image testing chart is placed above the camera module 3. (3) The camera module 3 is activated and takes an image of the image testing chart.

In step S11, the processor 41 converts the image of the image testing chart into a computer-recognizable format. In step S12, the signal output port 42 transmits the converted image to the computer 1.

In step S13, the area dividing module 10 of the computer 1 divides the transmitted image into 4 testing areas. The 4 testing areas includes: shading testing area A, resolution testing area B, color testing area C, and grayness testing area D. Then, the image testing module 11 computes values of the testing factors of the testing areas. The method of computing the values of the testing factors of the testing areas includes the steps described in the following paragraphs.

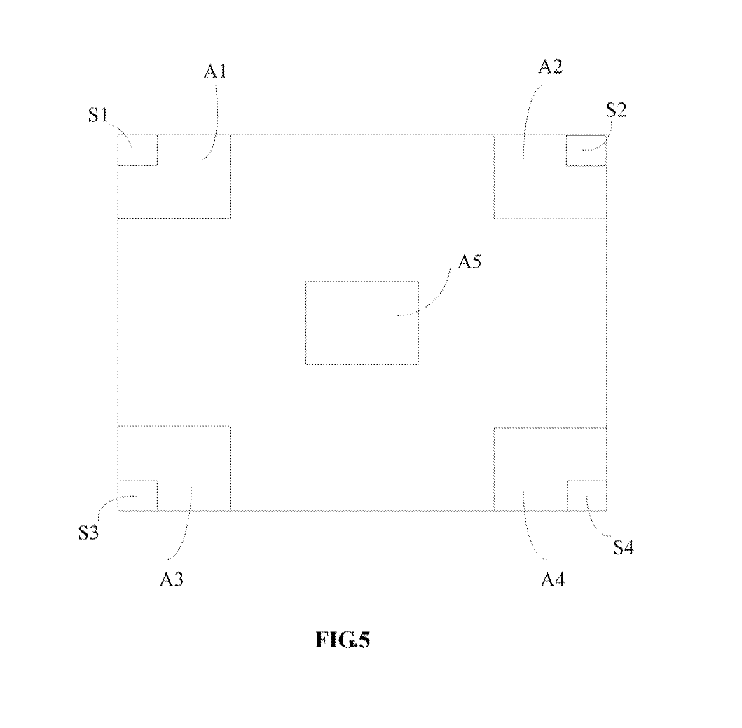

In step S14, the shading testing sub-module 110 computes brightness values of the shading testing area A. Referring to FIG. 5, which is a diagram of the shading testing area A divided from the image testing chart. The shading testing area A is a uniform white area. The shading testing area A has 5 first testing sub-areas A1˜A5, and 4 second testing sub-areas S1˜S4. The 5 first testing sub-areas are respectively located on the corners and center of the shading testing area A. The 4 second testing sub-areas are respectively located on the corners of 4 first testing sub-areas which are located on the corners of the shading testing area A. The shading testing sub-module 110 respectively computes the brightness values a1˜a5 of the 5 first testing sub-area A1˜A5 and the brightness values s1˜s4 of the 4 second testing sub-areas S1˜S4.

In step S15, the color testing sub-module 111 computes color values of the color testing area C. The color testing area C of the preferred embodiment is composed of 7 color testing sub-areas having different colors. The colors may include white, yellow, cyan, green, magenta, red and blue. The color testing sub-module 111 computes color values of the 7 color testing sub-areas. The color value is an average of pixel values of all points in the each color testing sub-area, and is composed of R (red), G (green), and B (blue). The R, G, and B are tricolor of a color, and the range of the R, G, and B is 0˜255. In the preferred embodiment, the color testing sub-module 111 computes 7 groups of color values: (Rwhite, Gwhite, Bwhite) (Ryellow, Gyellow, Byellow) (Rcyan, Gcyan, Bcyan) (Rgreen, Ggreen, Bgreen) (Rmagenta, Gmagenta, Bmagenta) (Rred, Gred, Bred) (Rblue, Gblue, Bblue).

In step S16, the grayness testing sub-module 112 computes grayness values of the grayness testing area D. The grayness testing area B of the preferred embodiment is composed of 7 grayness testing sub-areas having increasing or decreasing grayness. The grayness testing sub-module 112 computes grayness values of the 7 grayness testing sub-areas. The grayness value is an average of pixel values of all points in the each grayness testing sub-area, and is composed of R, G, and B.

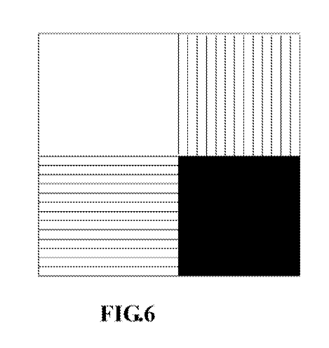

In step S17, the resolution testing sub-module 113 computes resolution values of the resolution testing area B. Referring to FIG. 6, which is a diagram of the resolution testing area B divided from the image testing chart. The resolution testing area B is composed of 5 sub-areas. Each sub-area is composed of 4 blocks, including white, black, vertical line and horizontal line. The resolution testing sub-module 111 computes resolution values of the 5 sub-areas. The range of the resolution value is 0˜1.

In step S18, the comparison module 12 compares the values computed above with respective predetermined values for determining whether the test factors are satisfactory.

The comparison module 12 compares the result of a first formula 1−Min (a1, a2, a3, a4)/a5 with a first predetermined shading value. If the result of the first formula is mathematically greater than the first predetermined shading value, it means that too much shading exists in the first testing areas A1˜A5. Thus, the shading testing of the camera module 3 is unsatisfactory.

The comparison module 12 compares the result of a second formula Max (a1, a2, a3, a4)/Min (a1, a2, a3, a4) with a second predetermined shading value. If the result of the second formula is mathematically greater than the second predetermined shading value, it means that a bigger shading exists in the first testing areas A1˜A4. Thus, the shading testing of the camera module 3 is still unsatisfactory.

The comparison module 12 compares the result of a third formula Min (s1/a1, s2/a2, s3/a3, s4/a4) with a third predetermined shading value. If the result of the third formula is mathematically less than the third predetermined value, it means that small amounts of shading exist in the second testing areas S1˜S4. Thus, the shading testing of the camera module 3 is still unsatisfactory.

The comparison module 12 compares the color values: Rwhite, Gwhite, Bwhite) (Ryellow, Gyellow, Byellow) (Rcyan, Gcyan, Bcyan) (Rgreen, Ggreen, Bgreen) (Rmagenta, Gmagenta, Bmagenta) (Rred, Gred, Bred) (Rblue, Gblue, Bblue) with respective predetermined color values for determining whether the color testing is satisfactory. For example, if the color testing sub-module 111 calculates that Rwhite=200, Gwhite=150, Bwhite=255, and if corresponding predetermined color value are Rwhite=100˜200, Gwhite=100˜200, Bwhite=100˜255, Rwhite, Gwhite, Bwhite are satisfactory. Otherwise, if the color testing sub-module 111 calculates that Rwhite=50, Gwhite=150, Bwhite=255, and if corresponding predetermined color values are Rwhite=100˜200, Gwhite=100˜200, Bwhite=100˜255, then Rwhite, Gwhite, Bwhite are unsatisfactory.

The comparison module 12 compares the grayness values with respective predetermined grayness values for determining whether the grayness testing are satisfactory. The method of comparing the grayness values with the respective predetermined grayness values is similar with the method of comparing the color values with the respective predetermined color values described above.

The comparison module 12 compares the resolution values with respective predetermined resolution values for determining whether the resolution testing is satisfactory. If all the resolution values are among the predetermined resolution values ranges, the resolution testing is satisfactory. Otherwise, if any of the resolution values are out of the predetermined resolution values range, the resolution testing is unsatisfactory.

The predetermined values mentioned above (including predetermined shading values, predetermined color values, predetermined grayness values, and predetermined resolution values) are selected according to current test conditions and requirements.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for testing a camera module, the system comprising a computer and a testing fixture, the testing fixture being connected with the computer, and configured for holding the camera module, converting an image, of an image testing chart, obtained by the camera module into a computer-recognizable format, and transmitting the converted image to the computer, the computer comprising:
an area dividing module configured for dividing the image into several testing areas;
an image testing module configured for computing values of test factors of the testing areas; and
a comparison module configured for determining whether the test factors are satisfactory through comparing the values of the test factors with respective predetermined values.

2. The system according to claim 1, wherein the image testing chart comprises: a shading image testing chart, a color image testing chart, a grayness image testing chart, and a resolution image testing chart.

3. The system according to claim 2, wherein the testing areas comprise: a shading testing area, a color testing area, a grayness testing area, and a resolution testing area.

4. The system according to claim 3, wherein the test factors comprise: shading testing, color testing, grayness testing, and resolution testing.

5. The system according to claim 3, wherein the values of the test factors comprise:
brightness values of the shading testing area, color values of the color testing area, grayness values of the grayness testing area, and resolution values of the resolution testing area.

6. The system according to claim 5, wherein the image testing module comprises:
a shading testing sub-module configured for computing the brightness values of the shading testing area;
a color testing sub-module configured for computing the color values of the color testing area;
a grayness testing sub-module configured for computing the grayness values of the grayness testing area; and
a resolution testing sub-module configured for computing the resolution values of the resolution testing area.

7. A computer-based method for testing a camera module, the method comprising:
a step wherein devices are installed, the step comprising: holding the camera module on a testing fixture; connecting the camera module with a computer through a signal conversion unit of the testing fixture; placing an image testing chart above the camera module; and turning on the camera module for obtaining an image of the image testing chart;
a step where image obtained by the camera module is converted into a computer-recognizable format;
transmitting the converted image to the computer;
dividing the image into several testing areas;
computing values of test factors of the testing areas; and
determining whether the test factors are satisfactory through comparing the computed values of the test factors with respective predetermined values.

8. The method according to claim 7, wherein the image testing chart comprises: a shading image testing chart, a color image testing chart, a grayness image testing chart, and a resolution image testing chart.

9. The method according to claim 8, wherein the testing areas comprise: a shading testing area, a color testing area, a grayness testing area, and a resolution testing area.

10. The method according to claim 9, wherein the testing factors comprise: shading testing, color testing, grayness testing, and resolution testing.

11. The method according to claim 9, wherein the values of the test factors comprise: brightness values of the shading testing area, color values of the color testing area, grayness values of the grayness testing area, and resolution values of the resolution testing area.

12. The method according to claim 11, wherein the step of computing values of test factors of the testing areas comprises:
computing the brightness values of the shading testing area;
computing the color values of the color testing area;
computing the grayness values of the grayness testing area; and
computing the resolution values of the resolution testing area.
